(19) United States
(12) Patent Application Publication
(10) Pub. No.: US 2017/0328749 A1
(43) Pub. Date: Nov. 16, 2017

(54) METALLIC DECORATIVE PART FOR VEHICLE DISPLAY DEVICE AND VEHICLE DISPLAY DEVICE

(71) Applicant: Yazaki Corporation, Tokyo (JP)

(72) Inventors: Tatsuya Hattori, Shizuoka (JP); Sunao Fujita, Shizuoka (JP)

(21) Appl. No.: 15/666,925

(22) Filed: Aug. 2, 2017

Related U.S. Application Data
(63) Continuation of application No. PCT/JP2015/056981, filed on Mar. 10, 2015.

(30) Foreign Application Priority Data
Mar. 6, 2015 (JP) 2015-044217

(51) Int. Cl. G01D 13/04; B60K 37/04

(52) U.S. Cl. CPC G01D 13/04; B60K 37/04

(57) ABSTRACT

A metallic decorative part for a vehicle display device includes a substrate body molded with a synthetic resin, a metal thin film made of metal and provided on a surface of the substrate body, and a plurality of grooves formed on a surface of the metal thin film in accordance with a shape of the surface of the substrate body. The plurality of grooves are formed so that the radius of the curved surface of a corner forming an apex between adjacent grooves is larger than 0 and equal to or smaller than 38.0 μm. Accordingly, the metallic decorative part for a vehicle display device can appropriately ensure metal texture to be given to a viewer in a structure in which the metal thin film is provided on the surface of the substrate body made of a resin.

### CROSS-REFERENCE TO RELATED APPLICATION

This application is a continuation application of International Application PCT/JP2015/056981, filed on Mar. 10, 2015, and designating the U.S., the entire contents of which are incorporated herein by reference.

### BACKGROUND OF THE INVENTION

### 1. Field of the Invention

The present invention relates to a metallic decorative part for a vehicle display device and a vehicle display device.

### 2. Description of the Related Art

As a metallic decorative part for a vehicle display device in the related art that is applied to a vehicle display device, for example, Japanese Patent Application Laid-open No. 2007-232403 discloses a decorative member for a vehicle instrument including a substrate which is made of a translucent material and on which display designs are formed and a primer layer and a metal coating that are laminated on the front surface of the substrate and a portion except for the front surfaces of the display designs from the substrate in this order.

Incidentally, the decorative member for a vehicle instrument disclosed in Japanese Patent Application Laid-open No. 2007-232403 has a room for further improvement in terms of ensuring more appropriate metal texture.

### SUMMARY OF THE INVENTION

The present invention has been made in consideration of the above-mentioned circumstances, and an object of the present invention is to provide a metallic decorative part for a vehicle display device and a vehicle display device that can appropriately ensure metal texture to be given to a viewer in a structure in which a metal thin film is provided on the surface of a substrate body made of a resin.

In order to achieve the above mentioned object, a metallic decorative part for a vehicle display device according to one aspect of the present invention includes a substrate body that is molded with a synthetic resin; a metal thin film that is made of metal and is provided on a surface of the substrate body; and a plurality of grooves that are formed on a surface of the metal thin film in accordance with a shape of the surface of the substrate body, wherein the plurality of grooves are formed so that a radius of a curved surface of a corner forming an apex between adjacent grooves is larger than 0 and equal to or smaller than 38.0 μm.

According to another aspect of the present invention, in the metallic decorative part for a vehicle display device, it is possible to configure that the plurality of grooves are formed so that a radius of a curved surface of a corner forming an apex between adjacent grooves is larger than 0 and equal to or smaller than 36.0 μm.

According to still another aspect of the present invention, in the metallic decorative part for a vehicle display device, it is possible to configure that the plurality of grooves are formed so that a radius of a curved surface of a corner forming an apex between adjacent grooves is larger than 0 and equal to or smaller than 33.0 μm.

According to still another aspect of the present invention, in the metallic decorative part for a vehicle display device, it is possible to configure that the substrate body is formed by including a cycloolefin polymer resin, and the metal thin film is formed by including titanium.

In order to achieve the above mentioned object, a vehicle display device according to still another aspect of the present invention includes a display unit that displays information about a vehicle; and a metallic decorative part for the vehicle display device that includes a substrate body molded with a synthetic resin, a metal thin film made of metal and provided on a surface of the substrate body, and a plurality of grooves formed on a surface of the metal thin film in accordance with a shape of the surface of the substrate body, wherein the plurality of grooves are formed so that a radius of a curved surface of a corner forming an apex between adjacent grooves is larger than 0 and equal to or smaller than 38.0 μm.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating the schematic structure of a vehicle display device according to an embodiment;

FIG. 2 is a partial cross-sectional view taken along line A-A of FIG. 1;

FIG. 3 is a front view illustrating the schematic structure of a character plate that is applied to the vehicle display device according to the embodiment;

FIG. 4 is a schematic cross-sectional view illustrating the schematic structure of the character plate that is applied to the vehicle display device according to the embodiment;

FIG. 5 is a schematic diagram illustrating the radius of the curved surface of a corner forming an apex of a groove of the character plate that is applied to the vehicle display device according to the embodiment;

FIG. 6 is a diagram illustrating an example of measured data about the character plate that is applied to the vehicle display device according to the embodiment; and

FIG. 7 is a diagram illustrating results of sensory evaluation tests for character plates according to Examples.

### DETAILED DESCRIPTION OF THE PREFERRED EMBODIMENTS

An embodiment of the present invention will be described in detail below with reference to the drawings. Meanwhile, the present invention is not limited by this embodiment. Further, components of the following embodiment include components, which can be easily substituted by those skilled in the art, or substantially the same components as the components.

### EMBODIMENT

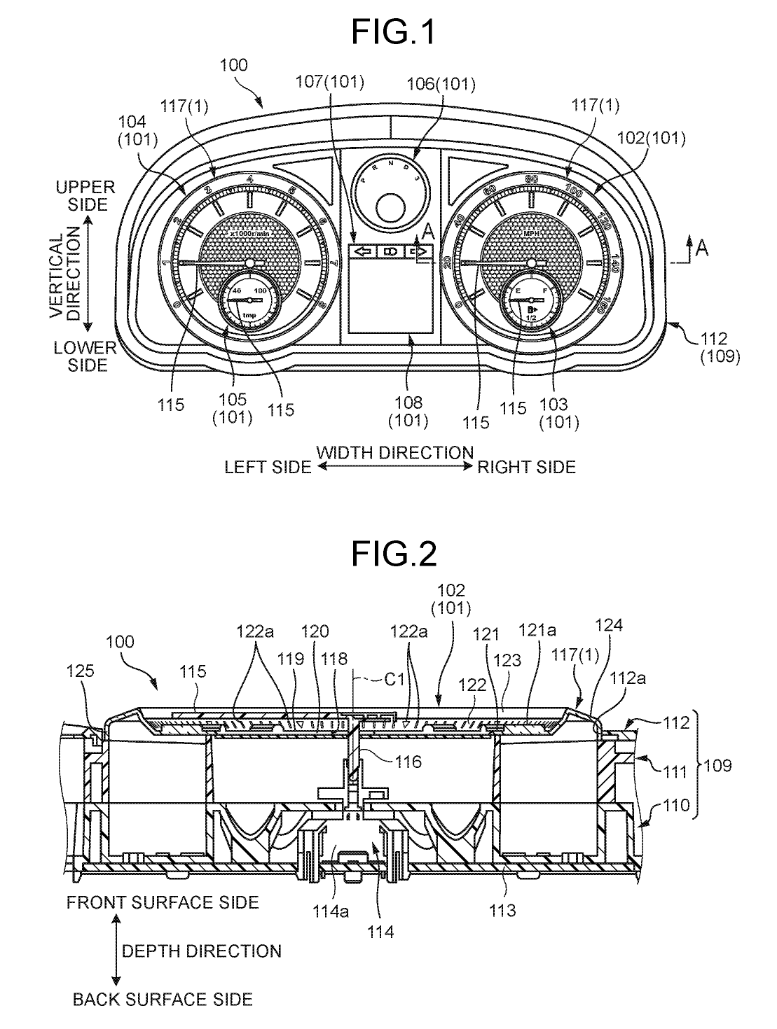

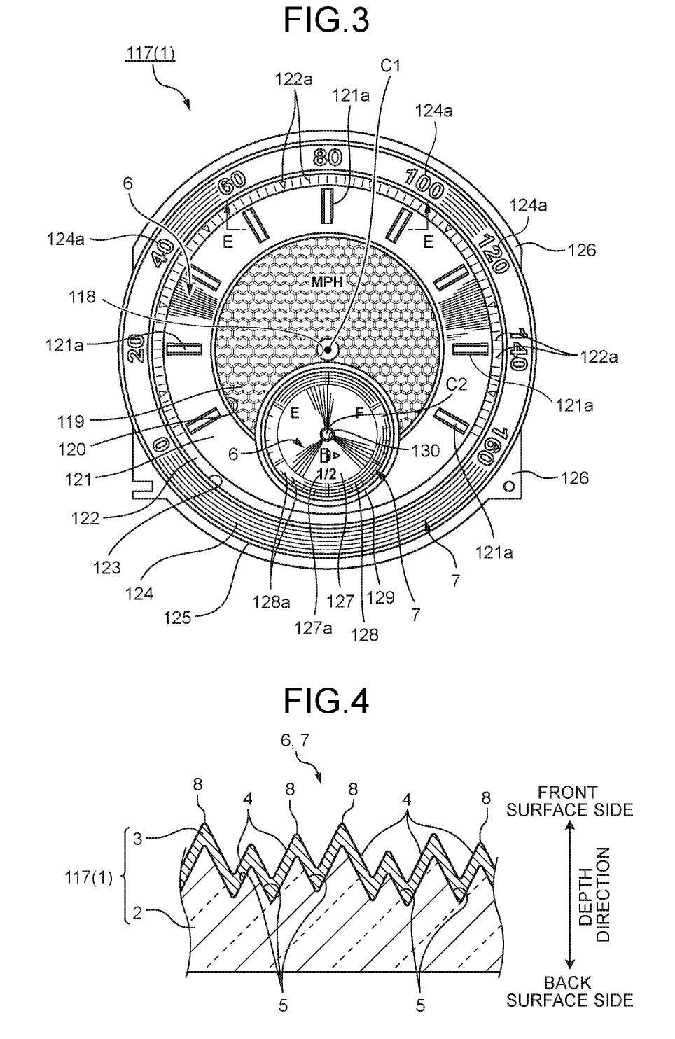

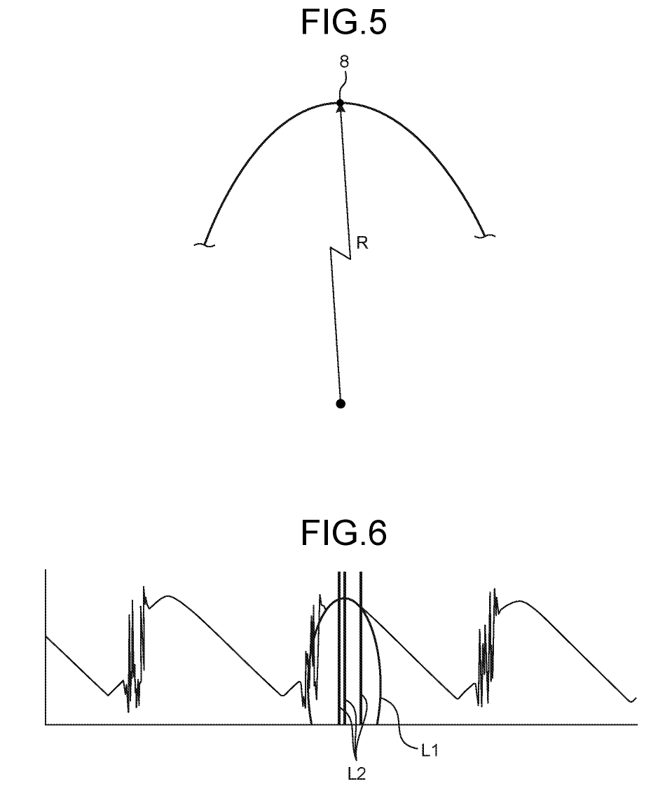

FIG. 1 is a front view illustrating the schematic structure of a vehicle display device according to an embodiment. FIG. 2 is a partial cross-sectional view taken along line A-A of FIG. 1. FIG. 3 is a front view illustrating the schematic structure of a character plate that is applied to the vehicle display device according to the embodiment. FIG. 4 is a schematic cross-sectional view illustrating the schematic structure of the character plate that is applied to the vehicle display device according to the embodiment. FIG. 5 is a schematic diagram illustrating the radius of the curved surface of a corner forming an apex of a groove of the character plate that is applied to the vehicle display device according to the embodiment. FIG. 6 is a diagram illustrating an example of measured data about the character plate that is applied to the vehicle display device according to the embodiment.

As illustrated in FIGS. 1 and 2, a decorative part 1 as a metallic decorative part for a vehicle display device according to this embodiment is applied to a vehicle display device 100 that is to be mounted on a vehicle. The vehicle display device 100 is a component that forms a so-called in-vehicle meter; and is mounted on, for example, an instrument panel provided on a dashboard of the vehicle and displays various kinds of information about the vehicle as information that is to be provided for the drive of the vehicle. The vehicle display device 100 includes a display unit 101 that displays information about the vehicle, and a decorative part 1 that is built in each unit of the vehicle display device 100 including the display unit 101. Further, since a metal thin film 3 is provided on the surface of a substrate body 2 made of a resin so as to form the decorative part 1 and the metal thin film 3 is formed in a predetermined shape, the vehicle display device 100 appropriately ensures metal texture that is to be given to a viewer.

Meanwhile, the width direction of the vehicle display device 100 illustrated in FIG. 1 typically corresponds to the width direction of the vehicle to which the vehicle display device 100 is applied. In the following description, the left side (the left side in FIG. 1) of the front side of the vehicle display device 100 may be referred to as the left side in the width direction of the vehicle display device 100 and the right side (the right side in FIG. 1) of the front side of the vehicle display device 100 may be referred to as the right side in the width direction of the vehicle display device 100. Further, the depth direction of the vehicle display device 100 illustrated in FIG. 2 typically corresponds to the front-back direction of the vehicle to which the vehicle display device 100 is applied. Furthermore, the front surface side of the vehicle display device 100 is a side facing the driver's seat of the vehicle, and is typically a side that is viewed by a driver seated in the driver's seat. On the other hand, the back surface side of the vehicle display device 100 is a side opposite to the front surface side in the depth direction, and is typically a side that is housed in the instrument panel.

The display unit 101 is to display various kinds of information about the vehicle. Here, for example, the display unit 101 includes a speedometer 102 that displays the speed of a vehicle as information about the vehicle, a fuel gauge 103 that displays the amount of residual fuel, a tachometer 104 that displays the output rotational speed of a power source for traveling, a water temperature gauge 105 that displays the temperature of a coolant, a shift display unit 106 that displays a shift position, a turn display unit 107 that shows the operating states of direction indicators (winkers), a multi-display unit 108 that shows other driving assistance information, and the like. The display unit 101 is disposed in a housing 109 housing the respective units of the vehicle display device 100, and the display surface of the display unit 101 for various kinds of information is exposed to the front surface side in the depth direction. The housing 109 is made of a resin material or the like. For example, the housing 109 includes a back case 110 that is disposed on the back surface side in the depth direction, an intermediate case 111 that is disposed on the front surface side of the back case 110 in the depth direction, and a facing 112 that is disposed on the front surface side of the intermediate case 111 in the depth direction. The display unit 101 is disposed in a space that is partitioned by the back case 110, the intermediate case 111, and the facing 112. Further, the display surface of each display unit 101 is exposed to the front surface side in the depth direction through an opening 112a (see FIG. 2) formed in the facing 112 of the housing 109. Here, the display surface of the fuel gauge 103 of the display unit 101 is built in the display surface of the speedometer 102 and the display surface of the water temperature gauge 105 of the display unit 101 is built in the display surface of the tachometer 104 likewise. In the housing 109, the speedometer 102 and the fuel gauge 103 of the display unit 101 are disposed on the right side in the width direction, the tachometer 104 and the water temperature gauge 105 thereof are disposed on the left side in the width direction, and the shift display unit 106, the turn display unit 107, and the multi-display unit 108 thereof are disposed between them.

For example, as illustrated in FIG. 2, an internal machine 114 of the speedometer 102 is fixed to a wiring board 113 disposed in the housing 109. The internal machine 114 includes a motor 114a as a drive source for a pointer 115, and a rotating shaft 116 of the pointer 115 protrudes from the motor 114a. The fuel gauge 103, the tachometer 104, and the water temperature gauge 105 also have substantially the same structure as the speedometer 102. The facing 112 covers the wiring board 113, the internal machine 114, and the like, and the display surface of each display unit 101 (the speedometer 102, the fuel gauge 103, the tachometer 104, the water temperature gauge 105, the shift display unit 106, the turn display unit 107, the multi-display unit 108, and the like) is exposed to the front surface side in the depth direction from the opening 112a as described above. Meanwhile, the front surface side of the display unit 101 of the vehicle display device 100 in the depth direction is protected by a transparent cover mounted on the housing 109.

The decorative part 1 is a part that forms a decorative member for a portion exposed to the front surface side in the depth direction and positioned within the field of view of an occupant including a driver in the vehicle display device 100. The decorative part 1 is applied to each of character plates 117 that are built in, for example, the display unit 101, here, the speedometer 102, the fuel gauge 103, the tachometer 104, the water temperature gauge 105, and the like. The character plates 117 are to form the display surfaces of the speedometer 102, the fuel gauge 103, the tachometer 104, the water temperature gauge 105, and the like that are exposed to the front surface side in the depth direction from the opening 112a of the facing 112. Each of the character plates 117 includes decorations of graduations that are to be pointed by the pointer 115, and decorations, such as various designs, symbols, and character strings, about measured values corresponding to the graduations.

The speedometer 102 and the character plate 117 of the fuel gauge 103 built in the display surface of the speedometer 102 will be described below with reference to FIGS. 2, 3, 4, and the like by way of example. Meanwhile, the tachometer 104 and the character plate 117 of the water temperature gauge 105 built in the display surface of the tachometer 104 have the same structure as the speedometer 102 and the character plate 117 of the fuel gauge 103.

The front surface of the character plate 117, which is formed as the decorative part 1, in the depth direction forms a display surface. Here, the character plate 117 is formed in a substantially circular shape as a whole. A shaft hole 118 is formed in an area of the character plate 117 that includes a central axis line C1 of the substantially circular shape. The shaft hole 118 is a hole through which the rotating shaft 116 of the pointer 115 of the speedometer 102 passes, and passes through the character plate 117 in the depth direction. The shaft hole 118 is formed in a substantially circular shape of which the center is positioned on the central axis line C1. A central disc portion 119, a boundary-standing-surface portion 120, a speedometer-main-graduation portion 121, a speedometer-auxiliary-graduation portion 122, a frame wall portion 123, a speedometer-character display unit 124, and a cylindrical end face portion 125 are formed on the character plate 117 in a substantially annular shape so as to be concentrically arranged around the central axis line C1 as a center in this order toward the outside from the shaft hole 118 in a radial direction. The speedometer-main-graduation portion 121, the speedometer-auxiliary-graduation portion 122, the speedometer-character display unit 124, and the like of the character plate 117 function as a portion corresponding to the display surface of the speedometer 102.

The central disc portion 119 is formed in a substantially annular shape on the outside of the shaft hole 118 in the radial direction. The central disc portion 119 is formed in the shape of a honeycomb mesh, and is provided with a character string, such as the unit of a physical quantity displayed by the speedometer 102, here, “MPH”. The boundary-standing-surface portion 120 is connected to the outside of the central disc portion 119 in the radial direction, and is formed in a substantially annular shape. Here, the boundary-standing-surface portion 120 is formed as a substantially cylindrical standing surface that protrudes along the central axis line C1 from the central disc portion 119 toward the front surface side in the depth direction. The speedometer-main-graduation portion 121 is connected to the radial outside of the front end portion of the boundary-standing-surface portion 120 in the depth direction, and is formed in a substantially annular shape. The speedometer-main-graduation portion 121 is provided so as to correspond to a physical quantity displayed by the speedometer 102, here, the speed of the vehicle, and is provided with a plurality of main graduations 121a that are to be pointed by the pointer 115. The plurality of main graduations 121a are formed in the shape of a protrusion at regular intervals in the circumferential direction of the speedometer-main-graduation portion 121. The speedometer-auxiliary-graduation portion 122 is connected to the outside of the speedometer-main-graduation portion 121 in the radial direction, and is formed in a substantially annular shape. The speedometer-auxiliary-graduation portion 122 is formed so as to be slightly inclined with respect to the speedometer-main-graduation portion 121. The speedometer-auxiliary-graduation portion 122 is provided so as to correspond to a physical quantity displayed by the speedometer 102, here, the speed of the vehicle, and is provided with a plurality of auxiliary graduations 122a that are to be pointed by the pointer 115. The plurality of auxiliary graduations 122a are formed in the shape of a protrusion at regular intervals, here, at intervals smaller than the intervals of the plurality of main graduations 121a in the circumferential direction of the speedometer-auxiliary-graduation portion 122. The frame wall portion 123 is connected to the outside of the speedometer-auxiliary-graduation portion 122 in the radial direction, and is formed in a substantially annular shape. The frame wall portion 123 is formed so as to be slightly inclined with respect to the speedometer-auxiliary-graduation portion 122, in more detail, is formed so as to be more inclined with respect to the speedometer-main-graduation portion 121 than the speedometer-auxiliary-graduation portion 122. The speedometer-character display unit 124 is connected to the outside of the frame wall portion 123 in the radial direction, and is formed in a substantially annular shape. The speedometer-character display unit 124 is formed so as to be reversely inclined with respect to the frame wall portion 123. The speedometer-character display unit 124 is provided with a plurality of character strings 124a representing measured values, here, a plurality of character strings 124a representing the speed of the vehicle. “20”, “40”, “60”, and the like as the plurality of character strings 124a are formed in the shape of a protrusion at regular intervals in the circumferential direction of the speedometer-character display unit 124. The cylindrical end face portion 125 is connected to the outside of the speedometer-character display unit 124 in the radial direction, and is formed in a substantially annular shape. Here, the cylindrical end face portion 125 is formed as a substantially cylindrical standing surface that is folded back to the back surface side in the radial direction from the speedometer-character display unit 124 along the central axis line C1. Meanwhile, a mounting portion 126 or the like, which is used to install the character plate 117 on the housing 109 or the like, is formed at the character plate 117 on the outer side of the cylindrical end face portion 125 in the radial direction.

In addition, a fuel-gauge-disc portion 127, a fuel-gauge-graduation portion 128, and a boundary-annular portion 129 are formed so as to be built in portions of the character plate 117 of this embodiment corresponding to the central disc portion 119, the boundary-standing-surface portion 120, and the speedometer-main-graduation portion 121. A shaft hole 130 is formed in an area of the character plate 117 including a reference line C2 that is parallel to the central axis line C1 and is set at a position offset from the central axis line C1 (a position offset downward in FIG. 3). The shaft hole 130 is a hole through which the rotating shaft of a pointer 115 of the fuel gauge 103 passes, and passes through the character plate 117 in the depth direction. The shaft hole 130 is formed in a substantially circular shape of which the center is positioned on the reference line C2. A fuel-gauge-disc portion 127, a fuel-gauge-graduation portion 128, and a boundary-annular portion 129 are formed on the character plate 117 in a substantially annular shape so as to be concentrically arranged around the reference line C2 as a center in this order toward the outside from the shaft hole 130 in the radial direction. The fuel-gauge-disc portion 127, the fuel-gauge-graduation portion 128, and the like of the character plate 117 function as a portion corresponding to the display surface of the fuel gauge 103.

The fuel-gauge-disc portion 127 is formed in a substantially annular shape on the outside of the shaft hole 130 in the radial direction. The fuel-gauge-disc portion 127 is provided with character strings 127a that represent a physical quantity displayed by the fuel gauge 103, here, character strings 127a representing the amount of residual fuel, such as “½”, “E (the initial of Empty)”, and “F (the initial of Full)”, and various designs. The fuel-gauge-graduation portion 128 is connected to the outside of the fuel-gauge-disc portion 127 in the radial direction, and is formed in a substantially annular shape. The fuel-gauge-graduation portion 128 is provided so as to correspond to a physical quantity displayed by the fuel gauge 103, here, the amount of residual fuel, and is provided with a plurality of main graduations 128a that are to be pointed by the pointer 115. The plurality of graduations 128a are formed at regular intervals in the circumferential direction of the fuel-gauge-graduation portion 128. The boundary-annular portion 129 is connected to the outside of the fuel-gauge-graduation portion 128 in the radial direction, and is formed in a substantially annular shape. The boundary-annular portion 129 is interposed between the central disc portion 119, the boundary-standing-surface portion 120, the speedometer-main-graduation portion 121 and the fuel-gauge-disc portion 127, the fuel-gauge-graduation portion 128; and functions as a boundary between an area of the character plate 117 that functions as the display surface of the speedometer 102 and an area of the character plate 117 that functions as the display surface of the fuel gauge 103.

Further, the character plate 117, which is formed as the decorative part 1 of this embodiment, includes the substrate body 2 that is made of a synthetic resin, the metal thin film 3 that is made of metal and is provided on the surface of the substrate body 2, and a plurality of grooves 4 that are formed on the surface of the metal thin film 3 in accordance with the shape of the surface of the substrate body 2. The character plate 117 forms a layer structure in which the metal thin film 3 is laminated on the surface of the substrate body 2, the surface of the metal thin film 3 forms the display surface of the character plate 117, and decoration formed by patterns is provided in a predetermined area by the plurality of grooves 4 formed on the display surface.

Here, the surface of the substrate body 2 and the surface of the metal thin film 3 are the front surfaces thereof in the depth direction, that is, the surfaces thereof facing the driver's seat of the vehicle. Typically, the surface of the metal thin film 3 is the surface that is viewed by a driver or the like seated in the driver's seat.

Since the substrate body 2 is integrally molded with a synthetic resin by a mold, all of the central disc portion 119, the boundary-standing-surface portion 120, the speedometer-main-graduation portion 121, the speedometer-auxiliary-graduation portion 122, the frame wall portion 123, the speedometer-character display unit 124, the cylindrical end face portion 125, the mounting portion 126, the fuel-gauge-disc portion 127, the fuel-gauge-graduation portion 128, the boundary-annular portion 129, the main graduations 121a, the auxiliary graduations 122a, the character strings 124a, character strings 127a, and the graduations 128a having been described above are integrally formed. The metal thin film 3 is provided on the surface of the substrate body 2, and the plurality of grooves 4 are formed on the surface of the metal thin film 3 in accordance with the shape of the surface of the substrate body 2. In other words, grooves 5 corresponding to the shapes of the plurality of grooves 4, which are formed on the surface of the metal thin film 3, are formed on the surface of the substrate body 2 on which the metal thin film 3 is provided. When the substrate body 2 is integrally molded with a synthetic resin by a mold, the grooves formed on the molding surface of the mold are transferred to the surface of the substrate body 2, so that the grooves 5 are formed.

The plurality of grooves 4 of this embodiment form various graduation patterns on the surface of the character plate 117. For example, the character plate 117 of this embodiment is provided with so-called radial graduation patterns 6 that are formed on the surfaces of the speedometer-main-graduation portion 121 and the fuel-gauge-disc portion 127 by the plurality of grooves 4 and so-called spin graduation patterns 7 that are formed on the surfaces of the speedometer-character display unit 124 and the fuel-gauge-graduation portion 128 by the plurality of grooves 4. The radial graduation pattern 6 is a pattern in which the plurality of fine grooves 4 extend radially outward from a reference point (for example, a point positioned on the central axis line C1 or the reference line C2), which is set in advance, or the vicinity of the reference point, and may be referred to as a rising-sun-pattern. The spin graduation pattern 7 is a pattern in which the plurality of fine grooves 4 extend in a concentric annular shape or a spiral annular shape from a reference point (for example, a point positioned on the central axis line C1 or the reference line C2), which is set in advance, as a center.

The plurality of grooves 4, which form the radial graduation patterns 6 and the spin graduation patterns 7 of this embodiment, are formed so that the radius R of the curved surface of a corner 8 forming an apex between adjacent grooves 4 is larger than 0 and equal to or smaller than 38.0 μm. That is, in a case in which the radius of the curved surface of the corner 8 forming an apex between adjacent grooves 4 is denoted by “R”, the plurality of grooves 4 are formed so as to satisfy a conditional expression represented by the following numerical expression (1).

0<R≦38.0 μm (1)

More preferably, the plurality of grooves 4 are formed so that the radius R of the curved surface of the corner 8 forming an apex between adjacent grooves 4 is larger than 0 and equal to or smaller than 36.0 μm. That is, it is more preferable that the plurality of grooves 4 are formed so as to satisfy a conditional expression represented by the following numerical expression (2).

0<R≦36.0 m (2)

Most preferably, the plurality of grooves 4 are formed so that the radius R of the curved surface of the corner 8 forming an apex between adjacent grooves 4 is larger than 0 and equal to or smaller than 33.0 μm. That is, it is still more preferable that the plurality of grooves 4 are formed so as to satisfy a conditional expression represented by the following numerical expression (3).

0<R≦33.0 μm (3)

Meanwhile, the lower limit of the radius R of the curved surface of the corner 8 may be typically in a range in which the grooves can be manufactured.

Here, the radius R of the curved surface of the corner 8 forming an apex between adjacent grooves 4 corresponds to the radius of an arc coming into contact with the corner 8 as illustrated in FIG. 5. The character plate 117 formed as the decorative part 1 is formed in a shape in which the radius R of the curved surface of each of all corners 8 measured under predetermined measurement conditions set in advance satisfies any of the conditional expressions represented by the above-mentioned numerical expressions (1) to (3).

Meanwhile, examples of the measurement conditions, which are set in advance to measure the radius R of the curved surface of the corner 8 forming an apex between adjacent grooves 4, include the following conditions. That is, the radius R is measured by the following procedure with a “3D measuring laser microscope LEXT OLS4000 manufactured by Olympus Corporation” as a measuring device that is used to measure the radius R of the curved surface.

<Procedure 1> The image of the surface of the character plate 117, which is formed as the decorative part 1, is taken in an “imaging” mode by the “3D measuring laser microscope LEXT OLS4000 manufactured by Olympus Corporation”.

<Procedure 2> After the image is taken, a “measurement” tab is selected in the operation screen of the “3D measuring laser microscope LEXT OLS4000 manufactured by Olympus Corporation” (hereinafter, simply referred to as an “operation screen”) to switch a mode to “measurement” and “profile measurement” is selected in the operation screen. As a result, the profile data of the surface of the character plate 117 illustrated in FIG. 6 is displayed in the operation screen.

<Procedure 3> Next, “curvature” of “designation of measurement item” is selected in the operation screen. Accordingly, a circle L1 and straight lines L2 are displayed on the profile data of the surface of the character plate 117 displayed in <Procedure 2>. When the straight lines L2 are moved to the left and right on the profile data, the size of the circle L1 is changed according to the movement of the straight lines L2.

<Procedure 4> Then, the straight lines L2, which are displayed on the profile data of the surface of the character plate 117, are moved to adjust the circle L1 to the curved surface of the corner 8 forming an apex between adjacent grooves 4. The radius of the circle L1, which is adjusted to the curved surface of the corner 8 in this way, is the measured value of the radius R of the curved surface of the corner 8 forming an apex between adjacent grooves 4.

Since the character plate 117, which is formed as the decorative part 1, is formed in a shape in which the radius R of the curved surface of the corner 8 satisfies any of the conditional expressions represented by the above-mentioned numerical expressions (1) to (3), it is possible to reproduce sharp feeling, which is close to grooves formed by cutting performed on actual metal, on the plurality of grooves 4 that form the radial graduation patterns 6 and the spin graduation patterns 7.

Here, in order to realize a shape that satisfies any of the conditional expressions represented by the above-mentioned numerical expressions (1) to (3) in the character plate 117 formed as the decorative part 1, it is preferable that a synthetic resin that has high flowability and an excellent transfer property (in other words, followability with respect to the shape of the molding surface), here, a cycloolefin polymer (COP) resin is used as a synthetic resin forming the substrate body 2 and titanium is used as metal forming the metal thin film 3. Further, in regard to the character plate 117, it is preferable to form the metal thin film 3, which includes titanium, on the surface of the substrate body 2, which is molded into a predetermined shape with a synthetic resin including the cycloolefin polymer resin by a mold, by so-called sputtering.

More specifically, the substrate body 2 is integrally molded with a synthetic resin, which includes a cycloolefin polymer resin, by a mold. In this case, portions, which mold the respective portions (the central disc portion 119, the boundary-standing-surface portion 120, the speedometer-main-graduation portion 121, the speedometer-auxiliary-graduation portion 122, the frame wall portion 123, the speedometer-character display unit 124, the cylindrical end face portion 125, the mounting portion 126, the fuel-gauge-disc portion 127, the fuel-gauge-graduation portion 128, the boundary-annular portion 129, the main graduations 121a, the auxiliary graduations 122a, the character strings 124a, the character strings 127a, the graduations 128a, and the like) of the above-mentioned character plate 117, and a plurality of grooves corresponding to the pattern of the plurality of grooves 4, which form the above-mentioned radial graduation patterns 6 and the above-mentioned spin graduation patterns 7, are also formed on the molding surface of the mold that molds the substrate body 2. The basic shape of the mold corresponding to the respective portions of the character plate 117 is formed on the basis of working information that includes the information about the shape of the molding surface of the mold and the like by various working machines, for example, a numerical control (NC) milling machine and the like. Further, here, when fine grooves corresponding to the plurality of grooves 5 are formed on the molding surface of the mold, fine grooves corresponding to the plurality of grooves 5 are cut on the molding surface by various cutting tools, for example, an end mill, a diamond bit, and the like without using etching, buffing, polishing, and the like. When the grooves, which are formed on the molding surface of the mold, are transferred to the surface of the substrate body 2, the grooves 5 corresponding to the shapes of the plurality of grooves 4, which form the radial graduation patterns 6 and the spin graduation patterns 7, are molded on the substrate body 2.

Further, a film made of titanium is formed on the surface of the substrate body 2, on which the respective portions of the character plate 117 and the grooves 5 corresponding to the shapes of the plurality of grooves 4 forming the radial graduation patterns 6 and the spin graduation patterns 7 are molded, by sputtering as described above, so that the metal thin film 3 is provided on the surface of the substrate body 2. Here, sputtering is a method of forming a metal thin film 3, which is made of titanium, on the surface of the substrate body 2 as the target by applying a DC high voltage to inert gas, such as argon gas, filled in a vacuum vessel (chamber) to ionize the inert gas and making ionized ions collide with a metal ingot, here, a titanium ingot and making molecules/atoms of titanium, which are metal particles flicked from the ingot, adhere to the surface of the substrate body 2 as a target.

The sputtering is a method that can relatively increase an adhesive force of the metal thin film 3 to the substrate body 2.

Since the substrate body 2 is molded with a cycloolefin polymer resin that is a synthetic resin having high flowability and an excellent transfer property as described above, desired shapes required for the respective portions of the character plate 117 that are formed on the molding surface of the mold, the plurality of grooves 5 corresponding to the pattern of the plurality of grooves 4 that form the radial graduation patterns 6 and the spin graduation patterns 7, and the like can be faithfully transferred to the surface of the substrate body 2 from the molding surface.

Further, a film is formed on the surface of the substrate body 2 with titanium as metal, which has good adhesion to the substrate body 2 made of a cycloolefin polymer resin and can be sputtered, by sputtering to form the metal thin film 3. For this reason, since the adhesion of the metal thin film 3 to the substrate body 2 can be sufficiently ensured, for example, even though an undercoat or the like is not interposed between the metal thin film 3 and the surface of the substrate body 2, the separation of the metal thin film 3 from the substrate body 2 can be suppressed. Furthermore, since the metal thin film 3 includes titanium that is materially stable, for example, a topcoat is also not needed on the surface of the metal thin film 3. As a result, since the thickness of the metal thin film 3 can be made relatively small (for example, about 0.2 μm), it is possible to form the plurality of grooves 4, which form the radial graduation patterns 6 and the spin graduation patterns 7, in the shapes required for the conditional expressions (1) to (3) and the like without filling the plurality of grooves 5 formed on the surface of the substrate body 2.

The decorative part 1 (the character plate 117) having been described above includes the substrate body 2 that is molded with a synthetic resin, the metal thin film 3 that is made of metal and is provided on the surface of the substrate body 2, and the plurality of grooves 4 that are formed on the surface of the metal thin film 3 in accordance with the shape of the surface of the substrate body 2; and the plurality of grooves 4 are formed so that the radius R of the curved surface of a corner 8 forming an apex between adjacent grooves 4 is larger than 0 and equal to or smaller than 38.0 μm. More preferably, the plurality of grooves 4 are formed so that the radius R of the curved surface of the corner 8 forming an apex between adjacent grooves 4 is larger than 0 and equal to or smaller than 36.0 μm. Most preferably, the plurality of grooves 4 are formed so that the radius R of the curved surface of the corner 8 forming an apex between adjacent grooves 4 is larger than 0 and equal to or smaller than 33.0 μm. The vehicle display device 100 having been described above includes the display unit 101 that displays information about a vehicle, and the decorative part 1 (the character plate 117).

Accordingly, since the decorative part 1 (the character plate 117) and the vehicle display device 100 are formed in a shape in which the radius R of the curved surface of a corner 8 forming each of the apexes of the plurality of grooves 4, which are formed on the surface of the metal thin film 3 in accordance with the shape of the surface of the substrate body 2 formed by the molding of a resin, satisfies any of the conditional expressions represented by the above-mentioned numerical expressions (1) to (3), it is possible to reproduce sharp feeling, which is close to grooves formed by cutting performed on actual metal, on the plurality of grooves 4. Therefore, since the decorative part 1 and the vehicle display device 100 have a structure in which the metal thin film 3 is provided on the surface of the substrate body 2 as a resin molded product, a variation in quality can be suppressed and texture, which is close to actual metal, can be reproduced even in the case of a resin molded product as described above. For example, the manufacturing costs of the decorative part 1 and the vehicle display device 100 can be reduced in comparison with a case in which the decorative parts 1 are machined one by one. Further, since the weights of the decorative part 1 and the vehicle display device 100 can be reduced in comparison with a case in which the entire decorative part 1 is made of metal, the decorative part 1 and the vehicle display device 100 can contribute to the reduction of the weight of the vehicle. Accordingly, the decorative part 1 and the vehicle display device 100 can be reduced not only in cost but also weight. As a result, the decorative part 1 and the vehicle display device 100 can appropriately ensure metal texture, which is to be given to a viewer, in the structure in which the metal thin film 3 is provided on the surface of the substrate body 2 made of a resin.

In addition, according to the decorative part 1 (the character plate 117) having been described above, the substrate body 2 includes a cycloolefin polymer resin and the metal thin film 3 includes titanium. Accordingly, the combination of the substrate body 2 and the metal thin film 3 in the decorative part 1 and the vehicle display device 100 can be a combination that can ensure the good transfer property of the substrate body 2 of the decorative part 1, the workability of the metal thin film 3 of the decorative part 1 and the shape followability thereof caused by a reduction in thickness, good adhesion between the substrate body 2 and the metal thin film 3, and the like. That is, since the substrate body 2 is molded with a cycloolefin polymer resin, desired shapes required for the respective portions of the character plate 117 that are formed on the molding surface of the mold, the plurality of grooves 5 corresponding to the pattern of the plurality of grooves 4 that form the radial graduation patterns 6 and the spin graduation patterns 7, and the like can be faithfully transferred to the surface of the substrate body 2 from the molding surface. Further, since the metal thin film 3 is made of titanium, the metal thin film 3 can be formed by sputtering. Accordingly, since the thickness of the metal thin film 3 can be made relatively small, it is possible to faithfully form the plurality of grooves 4, which form the radial graduation patterns 6 and the spin graduation patterns 7, in the shapes required for the conditional expressions (1) to (3) and the like without filling the plurality of grooves 5 formed on the surface of the substrate body 2. Moreover, since the substrate body 2 and the metal thin film 3 can sufficiently ensure adhesion, the separation of the metal thin film 3 from the substrate body 2 can be suppressed. Even in this regard, the decorative part 1 and the vehicle display device 100 can appropriately ensure metal texture, which is to be given to a viewer, in a structure in which the metal thin film 3 is provided on the surface of the substrate body 2 made of a resin.

Meanwhile, the metallic decorative part for a vehicle display device and the vehicle display device according to the embodiment of the present invention, which have been described above, can be modified in various ways within the scope of claims without being limited to the above-mentioned embodiment.

In the above description, the decorative part 1 has been described as a part that is to be applied to the character plate 117 built in the speedometer 102, the fuel gauge 103, the tachometer 104, the water temperature gauge 105, and the like. However, the decorative part 1 is not limited thereto, and may be applied to other decorative members for a portion exposed to the front surface side in the depth direction and positioned within the field of view of an occupant including a driver in the vehicle display device 100. The decorative part 1 may be applied to annular decorative members (ring members) and the like that are provided around the facing 112, the speedometer 102, the fuel gauge 103, the tachometer 104, the water temperature gauge 105, and the like.

In the above description, the character plate 117 has been described as a plate of which the radial graduation pattern 6 is provided on each of the surface of the speedometer-main-graduation portion 121 and the surface of the fuel-gauge-disc portion 127 and the spin graduation pattern 7 is provided on each of the surface of the speedometer-character display unit 124 and the surface of the fuel-gauge-graduation portion 128. However, the character plate 117 is not limited thereto. The character plate 117 may be provided with a pattern, which is formed by the plurality of grooves 4, other than the radial graduation patterns 6 and the spin graduation patterns 7. The character plate 117 may be provided with, for example, a hairline graduation pattern in which vertical stripes are formed by the plurality of grooves 4, a hairline graduation pattern in which horizontal stripes are formed by the plurality of grooves 4, a graduation pattern in which the vertical stripes and the horizontal stripes cross each other, or the like.

In the above description, a cycloolefin polymer resin has been used as the synthetic resin forming the substrate body 2, titanium has been used as metal forming the metal thin film 3, and the metal thin film 3 has been formed on the surface of the substrate body 2 by sputtering. However, the present invention is not limited thereto. The substrate body 2 may be formed by including, for example, an acrylic resin, a polycarbonate (PC) resin, and the like. The metal thin film 3 may be formed by including, for example, aluminum, stainless steel, gold, silver, platinum, copper, zinc, nickel, chromium, tin, molybdenum, and the like. A method of forming the metal thin film 3 on the surface of the substrate body 2 may be, for example, vapor deposition or the like.

In the above description, a “3D measuring laser microscope LEXT OLS4000 manufactured by Olympus Corporation” has been used as a measuring device that is used to measure the radius R of the curved surface of a corner 8 forming an apex between adjacent grooves 4. However, the measuring device is not limited to the 3D measuring laser and other measuring devices may be used. In this case, predetermined measurement conditions, which are set in advance to measure the radius R of the curved surface of the corner 8 forming an apex between adjacent grooves 4, may be the same as the above-mentioned conditions.

### EXAMPLES

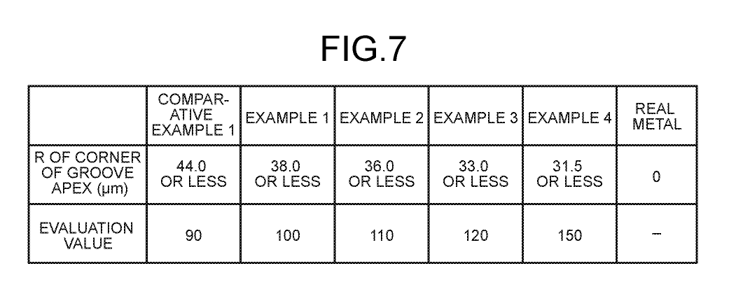

FIG. 7 is a diagram illustrating results of sensory evaluation tests for character plates according to Examples. Sensory evaluation tests for the character plate 117, which is formed as the decorative part 1, will be described below with reference to FIG. 7.

In the sensory evaluation tests, character plates, of which the radius R of the curved surface of a corner 8 forming each of the apexes of the plurality of grooves 4 satisfies any of the conditional expressions represented by the numerical expressions (1) to (3), have been actually produced as the above-mentioned character plate 117, which is formed as the decorative part 1 according to the embodiment. “Example 1” is a character plate on which a plurality of grooves 4 are formed so that the radius R of the curved surface of each of all corners 8 is 38.0 m or less, and satisfies the numerical expression (1). “Example 2” is a character plate on which a plurality of grooves 4 are formed so that the radius R of the curved surface of each of all corners 8 is 36.0 m or less, and satisfies the numerical expressions (1) and (2). “Example 3” is a character plate on which a plurality of grooves 4 are formed so that the radius R of the curved surface of each of all corners 8 is 33.0 m or less, and satisfies all of the numerical expressions (1) to (3). “Example 4” is a character plate on which a plurality of grooves 4 are formed so that the radius R of the curved surface of each of all corners 8 is 31.5 m or less, and satisfies all of the numerical expressions (1) to (3). On the other hand, “Comparative example 1” is a character plate that is actually produced so that the radius R of the curved surface of each corner 8 does not satisfy all of the conditional expressions represented by the numerical expressions (1) to (3), and is a character plate of which the radius R of the curved surface of each of all corners 8 is 44.0 or less and on which a plurality of grooves 4 are formed so as to have the radius R of the curved surface larger than at least 38.0 μm. Each of “Example 1”, “Example 2”, “Example 3, “Example 4”, and “Comparative example 1” is a character plate in which a cycloolefin polymer resin is used as a synthetic resin forming the substrate body 2, titanium is used as metal forming the metal thin film 3, and the metal thin film 3 is formed on the surface of the substrate body 2 by sputtering as in the above-mentioned embodiment. A measured value, which is measured in <Procedure 1> to <Procedure 4> by a “3D measuring laser microscope LEXT OLS4000 manufactured by Olympus Corporation” has been used as the radius R of the curved surface of each corner 8 of “Example 1”, “Example 2”, “Example 3, “Example 4”, and “Comparative example 1”. Meanwhile, character plates in which a plurality of grooves forming the radial graduation pattern 6 and the spin graduation pattern 7 are formed on the character plates, which are produced with real metal so as to have the same structure, by cutting have been actually produced and the grooves have been measured by the same method. The radius R of the curved surface in this case was “0”.

The sensory evaluation tests have been performed for “Example 1”, “Example 2”, “Example 3, “Example 4”, and “Comparative example 1” as objects, which are to be evaluated, in the following ways. That is, in a case (A-1) in which the objects to be evaluated and the real metal are arranged at predetermined positions in the prototype of the vehicle display device 100 illustrated in FIG. 1 in a room in which there is no external light, a case (A-2) in which the objects to be evaluated and the real metal are arranged at predetermined positions in the prototype of the vehicle display device 100 illustrated in FIG. 1 in a room in which there is external light, a case (B-1) in which the objects to be evaluated and the real metal are arranged in a box having an acrylic top plate (like an exhibition case) and the periphery of a portion other than the objects to be evaluated is covered with black cloth in a room in which there is no external light, and a case (B-2) in which the objects to be evaluated and the real metal are arranged in a box having an acrylic top plate and the periphery of a portion other than the objects to be evaluated is covered with black cloth in a room in which there is external light, an evaluator performed the sensory evaluation of the metal texture of the objects, which are to be evaluated, on the basis of one's experiences, and all the cases (A-1), (A-2), (B-1), and (B-2) were combined and were comprehensively evaluated. The evaluation value of an object, which is not unnatural even though being compared with the real metal and of which sufficient metal texture is obtained, was regarded as 100, and the evaluation value of an object, which is unnatural when being compared with the real metal and of which sufficient metal texture is not obtained, was regarded as a value smaller than 100. The fact that the evaluation value is larger than “100” means that metal texture is increased, and the fact that the evaluation value is smaller than “100” means that metal texture is poor. A designer for a vehicle display device (meter) was employed as the evaluator, and an average of evaluation values obtained by five evaluators was employed as the evaluation value. The sensory evaluation test was performed for each of the objects to be evaluated.

As a result of the sensory evaluation tests, as even apparent from FIG. 7, the evaluation value of “Comparative example 1” is “90” and “Comparative example 1” is unnatural when being compared with metal and the sufficient metal texture thereof is not obtained. However, it is apparent that the evaluation value of “Example 1” is “100”, the evaluation value of “Example 2” is “110”, the evaluation value of “Example 3” is “120”, the evaluation value of “Example 4” is “150”, and each example is not unnatural even though being compared with real metal and the sufficient metal texture thereof is obtained. In addition, since it is apparent that metal texture is increased as the radius R of the curved surface of a corner 8 is relatively reduced, it is apparent that the metal texture of “Example 4” satisfying the following numerical expression (4) is highest among “Example 1”, “Example 2”, “Example 3”, and “Example 4”.

O<R≦31.5 μm (4)

As described above, “Example 1”, “Example 2”, “Example 3”, and “Example 4” can appropriately ensure metal texture to be given to a viewer in a structure in which the metal thin film 3 is provided on the surface of the substrate body 2 made of a resin. Accordingly, it is apparent that “Example 1”, “Example 2”, “Example 3”, and “Example 4” have metallic appearance.

Since the metallic decorative part for a vehicle display device and the vehicle display device according to the present invention are formed so that the radius of the curved surface of a corner forming each of the apexes of the plurality of grooves, which are formed on the surface of the metal thin film in accordance with the shape of the surface of the substrate body formed by the molding of a resin, is larger than 0 and equal to or smaller than 38.0 μm, it is possible to reproduce sharp feeling, which is close to grooves formed by cutting performed on actual metal, on the plurality of grooves. Accordingly, since the metallic decorative part for a vehicle display device and the vehicle display device have a structure in which the metal thin film is provided on the surface of the substrate body as a resin molded product, a variation in quality can be suppressed and texture, which is close to actual metal, can be reproduced even in the case of a resin molded product as described above. As a result, the metallic decorative part for a vehicle display device and the vehicle display device have an effect of appropriately ensuring metal texture to be given to a viewer in a structure in which a metal thin film is provided on the surface of a substrate body made of a resin.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A metallic decorative part for a vehicle display device, the metallic decorative part comprising:
a substrate body that is molded with a synthetic resin;
a metal thin film that is made of metal and is provided on a surface of the substrate body; and
a plurality of grooves that are formed on a surface of the metal thin film in accordance with a shape of the surface of the substrate body, wherein
the plurality of grooves are formed so that a radius of a curved surface of a corner forming an apex between adjacent grooves is larger than 0 and equal to or smaller than 38.0 μm.

2. The metallic decorative part for a vehicle display device according to claim 1, wherein
the plurality of grooves are formed so that a radius of a curved surface of a corner forming an apex between adjacent grooves is larger than 0 and equal to or smaller than 36.0 μm.

3. The metallic decorative part for a vehicle display device according to claim 1, wherein
the plurality of grooves are formed so that a radius of a curved surface of a corner forming an apex between adjacent grooves is larger than 0 and equal to or smaller than 33.0 μm.

4. The metallic decorative part for a vehicle display device according to claim 2, wherein
the plurality of grooves are formed so that a radius of a curved surface of a corner forming an apex between adjacent grooves is larger than 0 and equal to or smaller than 33.0 μm.

5. The metallic decorative part for a vehicle display device according to claim 1, wherein
the substrate body is formed by including a cycloolefin polymer resin, and
the metal thin film is formed by including titanium.

6. The metallic decorative part for a vehicle display device according to claim 2, wherein
the substrate body is formed by including a cycloolefin polymer resin, and
the metal thin film is formed by including titanium.

7. The metallic decorative part for a vehicle display device according to claim 3, wherein
the substrate body is formed by including a cycloolefin polymer resin, and
the metal thin film is formed by including titanium.

8. The metallic decorative part for a vehicle display device according to claim 4, wherein
the substrate body is formed by including a cycloolefin polymer resin, and
the metal thin film is formed by including titanium.

9. A vehicle display device comprising:
a display unit that displays information about a vehicle; and
a metallic decorative part for the vehicle display device that includes a substrate body molded with a synthetic resin, a metal thin film made of metal and provided on a surface of the substrate body, and a plurality of grooves formed on a surface of the metal thin film in accordance with a shape of the surface of the substrate body, wherein
the plurality of grooves are formed so that a radius of a curved surface of a corner forming an apex between adjacent grooves is larger than 0 and equal to or smaller than 38.0 μm.
